(19) United States
(12) Patent Application Publication
(10) Pub. No.: US 2024/0362869 A1
(43) Pub. Date: Oct. 31, 2024

(54) OPTICAL DEVICE FOR AUGMENTED REALITY CAPABLE OF PROVIDING HIGH LUMINOUS UNIFORMITY

(71) Applicant: LETINAR CO., LTD, Anyang-si, Gyeonggi-do (KR)

(72) Inventors: Jeong Hun HA, Seoul (KR); Sung A KIM, Ansan-si, Gyeonggi-do (KR)

(73) Assignee: LETINAR CO., LTD, Anyang-si, Gyeonggi-do (KR)

(21) Appl. No.: 18/646,722

(22) Filed: Apr. 25, 2024

(30) Foreign Application Priority Data
Apr. 26, 2023 (KR) 10-2023-0054553

(51) Int. Cl. G06T 19/00; G02B 27/01

(52) U.S. Cl. CPC G06T 19/006; G02B 27/0172; G02B 27/0176; G02B 2027/0178

(57) ABSTRACT

Provided is an optical device for augmented reality capable of providing high luminous uniformity. According to an aspect of the present invention, there is provided an optical device for augmented reality, the optical device including: an optical means configured to allow virtual image light, output from an image output unit, to propagate through the interior thereof and transmit real object image light therethrough toward a pupil of a user; and a plurality of reflective units disposed in the optical means to transfer the virtual image light toward the pupil of the user; wherein the plurality of reflective units are each configured such that a dielectric coating layer coated with a dielectric material is formed on the reflective surface thereof that reflects incident virtual image light and transfers it to the pupil.

### CROSS-REFERENCE TO RELATED APPLICATION

This application claims the benefit of Korean Patent Application No. 10-2023-0054553 filed on Apr. 26, 2023, which is hereby incorporated by reference herein in its entirety.

### BACKGROUND

### 1. Technical Field

The present invention relates to an optical device for augmented reality, and more particularly, to an optical device for augmented reality that can increase luminous uniformity for virtual image light.

### 2. Description of the Related Art

Augmented reality (AR) refers to technology that superimposes virtual images on real images in the real world and then provides resulting images, thereby providing a user with virtual image information augmented from visual information in the real world, as is well known.

In order to provide augmented reality, there is required an optical combiner that allows a virtual image and a real image in the real world to be observed simultaneously. As such an optical combiner, there is known a method using a reflective unit such as a full mirror or a half mirror.

Furthermore, in order to expand the field of view (FoV) and the eyebox, a plurality of reflective units are frequently disposed in an optical means such as a lens.

However, when a plurality of reflective units are used as described above, the FoV and the eyebox can be expanded, but there is a problem in that the quantities of virtual image light transferred to the pupil through the respective reflective units are not uniform.

Therefore, it is difficult to keep the luminous uniformity of a virtual image, observed by a user, constant, which is a factor that makes it difficult to design an optical device for augmented reality.

[Related Art Literature]

Patent Document: Korean Patent No. 10-2436597 published on Aug. 23, 2022

### SUMMARY

The present invention has been conceived to overcome the above-described problems, and an object of the present invention is to provide an optical device for augmented reality that can increase luminous uniformity for virtual image light.

According to an aspect of the present invention, there is provided an optical device for augmented reality, the optical device including: an optical means configured to allow virtual image light, output from an image output unit, to propagate through the interior thereof and transmit real object image light therethrough toward a pupil of a user; and a plurality of reflective units disposed in the optical means to transfer the virtual image light toward the pupil of the user; wherein the plurality of reflective units are each configured such that a dielectric coating layer coated with a dielectric material is formed on the reflective surface thereof that reflects incident virtual image light and transfers it to the pupil.

In this case, the dielectric material may be at least any one of SiO₂, TiO₂, Al₂O₃, fluorinated ethylene propylene (FEP), polyvinylidene fluoride (PVDF), perfluoroalkoxy (PFA), ethylene tetrafluoroethylene (ETFE), and polyethylene terephthalate (PET).

The dielectric coating layer may be transparent.

In an embodiment, the product of the effective area and reflectance of each of the plurality of reflective units may have a value within a predetermined range.

The value within the predetermined range may be within the range of ±30% of a preset constant value.

At least some of the plurality of reflective units may have a different reflectance.

For the plurality of reflective units, the reflectance of each of the plurality of reflective units may be set such that the product of the effective area and reflectance of each of the plurality of reflective units falls within a predetermined range, and the dielectric coating layer may be formed by performing coating with a dielectric material corresponding to the set reflectance.

In an embodiment, the predetermined range may be the range of ±30% of a preset constant value.

The plurality of reflective units may each include a reflective member made of a metallic material, and the dielectric coating layer may be formed on the reflective surface of the reflective member that transfers incident virtual image light to the pupil by reflecting it.

According to another aspect of the present invention, there is provided an optical device for augmented reality, the optical device including: an optical means configured to allow virtual image light, output from an image output unit, to propagate through the interior thereof and transmit real object image light therethrough toward a pupil of a user; and a plurality of reflective units disposed in the optical means to transfer the virtual image light toward the pupil of the user; wherein the plurality of reflective units have the same reflectance; and wherein the size of each of the plurality of reflective units is formed such that the effective area of each of the plurality of reflective units has a value in a preset range.

In this case, the size (A(θₚ)) of each of the plurality of reflective units may have a value obtained by dividing a preset constant (A₀) by sin(θᵣ−θₚ) (where θₚ is the inclination angle between a normal line (NP) from the pupil and the center of each of the plurality of reflective units, and θᵣ is the inclination angle of each of the plurality of reflective units with respect to a straight line (NP1) parallel to the normal line (NP) from the pupil and extending from the center of each of the plurality of reflective units).

According to another aspect of the present invention, there is provided an optical device for augmented reality, the optical device including: an optical means configured to allow virtual image light, output from an image output unit, to propagate through the interior thereof and transmit real object image light therethrough toward a pupil of a user; and a plurality of reflective units disposed in the optical means to transfer the virtual image light toward the pupil of the user; wherein the plurality of reflective units have the same reflectance and size; and wherein the plurality of reflective units are arranged at the intervals that allow a density based on the effective area of each of the plurality of reflective units to have a value within a predetermined range.

In this case, the plurality of reflective units may be arranged at the intervals that allow the density (N(θₚ)) based on the effective area of each of the plurality of reflective units to have a value obtained by dividing a preset constant (C₀) by sin(θᵣ−θₚ) (where θₚ is the inclination angle between a normal line (NP) from the pupil and the center of each of the plurality of reflective units, and θᵣ is the inclination angle of each of the plurality of reflective units with respect to a straight line (NP1) parallel to the normal line (NP) from the pupil and extending from the center of each of the plurality of reflective units).

According to still another aspect of the present invention, there is provided a glasses-type augmented reality provision device including: optical devices for augmented reality each set forth above; a frame unit configured such that the optical devices for augmented reality are fixed thereto; and fixation units configured to be coupled to the frame unit and fix the glasses-type augmented reality provision device so that it can be worn on the face of a user.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, features, and advantages of the present invention will be more clearly understood from the following detailed description taken in conjunction with the accompanying drawings, in which:

FIGS. 1 to 3 show a side view, perspective view, and front view, respectively, of an optical device for augmented reality capable of providing high luminous uniformity (hereinafter simply referred to as an “optical device”) according to an embodiment of the present invention;

FIG. 4 shows a side view of a reflective unit according to the present invention;

FIG. 5 shows views illustrating the effect of a dielectric coating layer;

FIG. 6 shows a graph of reflectances depending on changes in the incidence angle of incident light with respect to the normal line from the surface of the dielectric coating layer;

FIG. 7 is a diagram illustrating the principle and operation of providing high luminous uniformity according to the present invention by using the properties of the dielectric coating layer;

FIG. 8 shows a side view of an optical device according to another embodiment of the present invention;

FIG. 9 shows a side view of an optical device according to still another embodiment of the present invention;

FIG. 10 shows a side view of an optical device according to still another embodiment of the present invention;

FIGS. 11 to 13 show a side view, perspective view, and front view, respectively, of an optical device according to still another embodiment of the present invention;

FIG. 14 shows a side view of an optical device according to still another embodiment of the present invention;

FIG. 15 shows a side view of an optical device according to still another embodiment of the present invention; and

FIGS. 16 and 17 show a perspective view and front view, respectively, of an embodiment of a glasses-type augmented reality provision device implemented in the form of smart glasses.

### DETAILED DESCRIPTION

Embodiments of the present invention will be described in detail below with reference to the accompanying drawings.

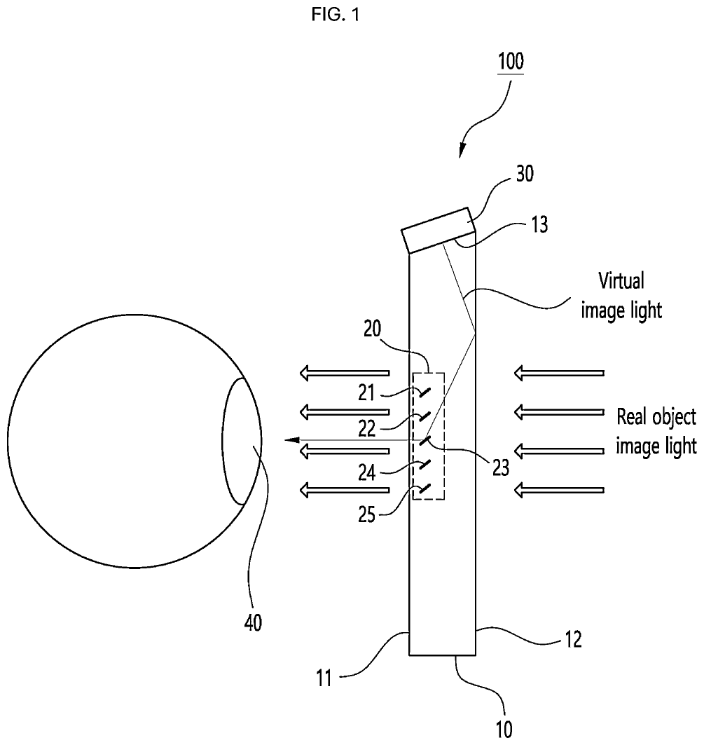

FIGS. 1 to 3 show a side view, perspective view, and front view, respectively, of an optical device 100 for augmented reality capable of providing high luminous uniformity (hereinafter simply referred to as the “optical device 100”) according to an embodiment of the present invention.

Referring to FIGS. 1 to 3, the optical device 100 includes an optical means 10 and a plurality of reflective units 21 to 25.

The optical means 10 is a means that transmits the real object image light, output from a real object present in the real world, therethrough toward a pupil 40 of a user.

Furthermore, the optical means 10 functions as a waveguide that allows the virtual image light, output from an image output unit 30, to propagate through the interior thereof and be output to the pupil 40.

The optical means 10 may be made of a transparent resin or glass material, and the plurality of reflective units 21 to 25 are embedded in the optical means 10, as will be described later.

The optical means 10 has a first surface 11 configured such that virtual image light and real object image light are output toward the pupil 40 of the user therethrough, and a second surface 12 disposed opposite the first surface 11 and configured such that real object image light enters therethrough.

Furthermore, the optical means 10 has a third surface 13 configured such that the virtual image light output from the image output unit 30 enters therethrough.

Meanwhile, the image output unit 30 is a means that outputs virtual image light, which is image light corresponding to a virtual image.

The virtual image refers to an image for augmented reality provided to a user, and may be a still image or a moving image.

The image output unit 30 may include a display unit (not shown) and an optical conversion unit (not shown).

The display unit is a device that displays a virtual image and outputs virtual image light corresponding to the displayed virtual image. The display unit may be a device such as a small-sized liquid crystal display (LCD), an organic light-emitting diode (OLED), a liquid crystal on silicon (LCoS), or a micro light-emitting diode (LED).

The optical conversion unit is a means that converts and outputs incident virtual image light according to a preset condition such as an optical path or a focal length. For example, the optical conversion unit may be a collimator that converts incident light into parallel light and outputs the parallel light.

Alternatively, the optical conversion unit may be a lens such as a convex or concave lens that converts incident light and outputs it so that a virtual image can be enlarged or reduced according to a preset design request.

Furthermore, the optical conversion unit may be a holographic or diffractive optical element.

Since the image output unit 30 itself is not a direct target of the present invention and is known in the prior art, a detailed description thereof will be omitted here.

The plurality of reflective units 21 to 25 are arranged to transfer the virtual image light propagating inside the optical means 10 to the pupil 40 of an eye of a user, thereby providing a virtual image to the user.

Although the plurality of reflective units 21 to 25 are embedded and disposed inside the optical means 10 in the embodiment of FIGS. 1 to 3, this is an example. Alternatively, the plurality of reflective units 21 to 25 may be disposed on an outer surface of the optical means 10, e.g., either the first surface 11 or the second surface 12.

In the embodiment of FIGS. 1 to 3, when the optical device 100 is disposed in front of the pupil 40 and then viewed, the plurality of reflective units 21 to 25 are arranged at intervals to appear like a two-dimensional array.

Real object image light is transferred to the pupil 40 through the spaces formed by the intervals between the plurality of reflective units 21 to 25, thereby providing a so-called see-through function.

Although it is preferable that the intervals between the plurality of reflective units 21 to 25 be the same, it is obvious that some of the intervals may be different.

Meanwhile, the plurality of reflective units 21 to 25 may have a shape such as the shape in which a single bar is disposed in each row or column.

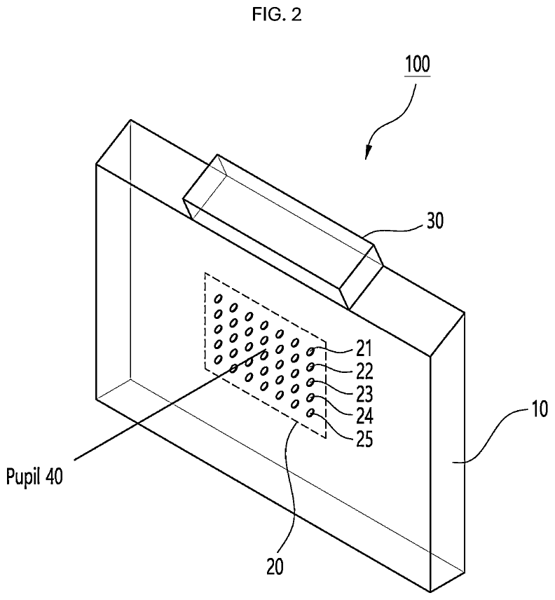

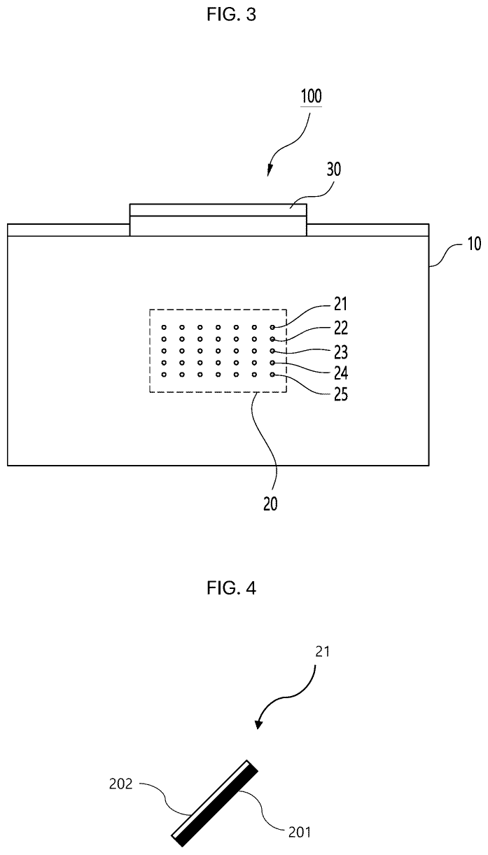

In FIGS. 1 to 3, for convenience of description, reference numerals are specified only for the plurality of reflective units 21 to 25 that are observed when viewed from a side, as shown in FIG. 1. However, it should be noted that throughout the present specification, the plurality of reflective units 21 to 25 refer to all the reflective units shown in FIGS. 2 and 3.

Furthermore, in FIGS. 1 to 3, the plurality of reflective units 21 to 25 will be collectively referred to as a reflective unit array 20.

In the embodiment of FIGS. 1 to 3, the virtual image light output from the image output unit 30 is reflected by total internal reflection on the second surface 12 of the optical means 10 and is then transferred to the plurality of reflective units 21 to 25, and the plurality of reflective units 21 to 25 transfer incident virtual image light to the pupil 40. Accordingly, each of the plurality of reflection units 21 to 25 is disposed at an appropriate inclination angle within the optical means 10 by taking into consideration the above-described optical paths.

That is, each of the plurality of reflective units 21 to 25 is disposed at an appropriate inclination angle inside the optical means 10 by taking into consideration the relative positions of the image output unit 30 and the pupil 40.

Meanwhile, in the present invention, the plurality of reflective units 21 to 25 are characterized in that the reflective surfaces thereof that transfer incident virtual image light to the pupil 40 by reflecting it are dielectrically coated.

That is, each of the plurality of reflective units 21 to 25 is characterized by a dielectric coating layer 202 (see FIG. 4) formed by applying a dielectric material onto the reflective surface thereof that transfers incident virtual image light to the pupil 40 by reflecting it.

FIG. 4 shows a side view of one reflective unit 21 selected from the plurality of reflective units 21 to 25 according to the present invention.

As shown in FIG. 4, the reflective unit 21 may be formed of a reflective member 201 made of a metallic material such as Ag or Al, but is not limited thereto. However, the reflective unit 21 may be formed of another material that can reflect incident virtual image light.

Furthermore, the dielectric coating layer 202 coated with a dielectric material is provided on a surface of the reflective member 201 of the reflective unit 21, i.e., the reflective surface of the reflective member 201 that transfers incident virtual image light to the pupil 40 by reflecting it.

In this case, at least any one of materials such as SiO₂, TiO₂, Al₂O₃, fluorinated ethylene propylene (FEP), polyvinylidene fluoride (PVDF), perfluoroalkoxy (PFA), ethylene tetrafluoroethylene (ETFE), and polyethylene terephthalate (PET) may be used as the dielectric material.

Furthermore, although it is preferable that the dielectric coating layer 202 be transparent, it may also be made of a translucent or opaque material.

Furthermore, it is obvious that the reflective unit 21 itself may be made of a dielectric material.

The reflective unit 21 provided with the dielectric coating layer 202 as described above has a reflectance for virtual image light that varies depending on the angle at which the virtual image light is incident. Using this property, the luminous uniformity of the virtual image light transferred to the pupil 40 by the plurality of reflective units 21 to 25 may be increased.

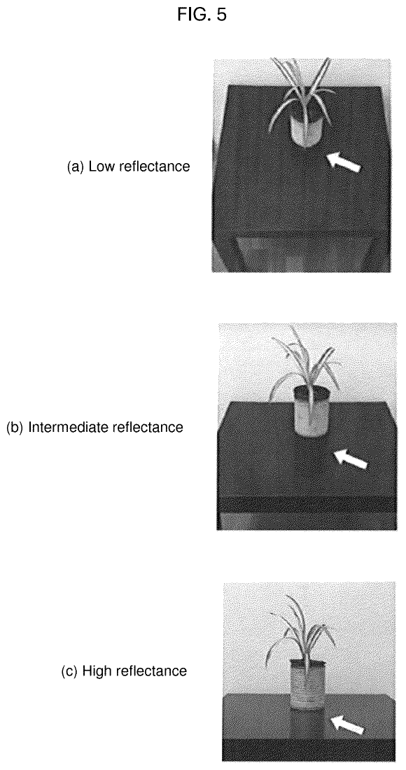

FIG. 5 shows views illustrating the effect of the dielectric coating layer 202, and depicts the phenomenon in which Fresnel reflection varies depending on the incidence angle of incident light with respect to the normal line from the surface of the dielectric coating layer 202.

FIG. 5(a) shows a case where the inclination angle between the normal line from the pupil 40 and the surface of the table on which the flower pot is placed is relatively large. In this case, the surface of the table has a transparent dielectric coating layer.

This case corresponds to a case where the incidence angle of incident light with respect to the normal line from the surface of the table is small. It can be seen that the shadow of the flower pot reflected on the surface of the table is rarely observed as shown in the view. That is, in the case of FIG. 5(a), the reflectance on the surface of the table is significantly low.

Furthermore, FIG. 5(c) is a case where the inclination angle between the normal line from the pupil 40 and the surface of the table is significantly small. This case corresponds to a case where the incidence angle of incident light with respect to the normal line from the surface of the table is large.

In this case, it can be seen that the shadow of the flower pot reflected on the surface of the table is clearly observed as shown in the view. Accordingly, in the case of FIG. 5(c), the reflectance on the surface of the table is significantly high.

Furthermore, FIG. 5(b) shows a case where the inclination angle between the normal line from the pupil 40 and the surface of the table is in the intermediate range between the inclination angle of FIG. 5(a) and the inclination angle of FIG. 5(c). This case corresponds to a case where the incidence angle of incident light with respect to the normal line from the surface of the table is in the intermediate range between the inclination angle of FIG. 5(a) and the inclination angle of FIG. 5(c).

In this case, it can be seen that the shadow of the flower pot reflected on the surface of the table is observed to some extent as shown in the view. This implies that the reflectance on the surface of the table is somewhere between the reflectance of FIG. 5(a) and the reflectance of FIG. 5(c).

As described above, the dielectric coating layer 202 has a reflectance that varies depending on the incidence angle of incident light incident on the dielectric coating layer 202 with respect to the normal from the surface of the dielectric coating layer 202.

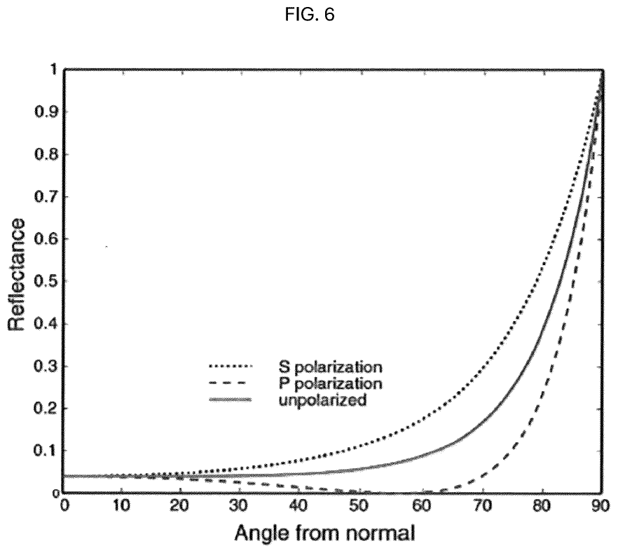

That is, as the incidence angle of incident light with respect to the normal line from the surface of the dielectric coating layer 202 increases, the reflectance becomes higher. In contrast, as the incidence angle of incident light decreases, the reflectance becomes lower. FIG. 6 shows a graph of reflectances depending on changes in the incidence angle of incident light with respect to the normal line from the surface of the dielectric coating layer 202.

As shown in FIG. 6, as the incidence angle of incident light with respect to the normal line from the surface of the dielectric coating layer 202 increases, the reflectance becomes larger. In particular, it can be seen that the reflectance increases rapidly from the point where the incidence angle is approximately 60 degrees.

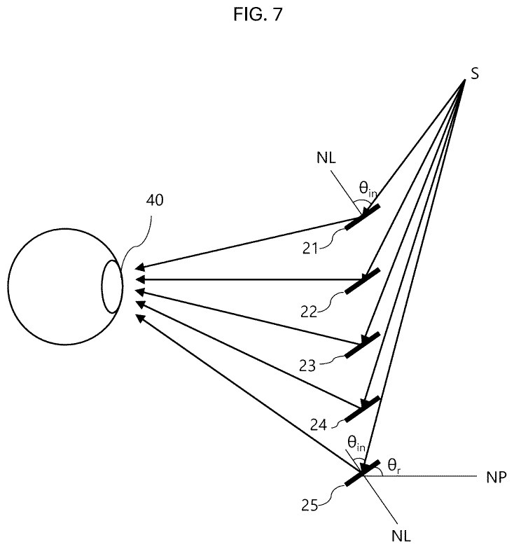

FIG. 7 is a diagram illustrating the principle and operation of providing high luminous uniformity according to the present invention by using the properties of the dielectric coating layer 202.

FIG. 7 is similar to FIG. 1. However, in FIG. 7, for convenience of description, only the plurality of reflective units 21 to 25 and the pupil 40 are shown, and the optical path of the virtual image light incident on each of the plurality of reflective units 21 to 25 and the optical path of the virtual image light reflected from the plurality of reflective units 21 to 25 and transferred to the pupil 40 are represented by the arrows.

In FIG. 7, as described above, the dielectric coating layer 202 is formed on the reflective surface of the reflective member 201 of each of the plurality of reflective units 21 to 25, and the inclination angles θᵣ of the plurality of reflective units 21 to 25 with respect to straight lines parallel to the normal line NP in the forward direction from the pupil 40 are all the same.

Furthermore, in FIG. 7, the plurality of reflective units 21 to 25 are arranged such that their respective centers are located on a vertical line when viewed from a side, as shown in the drawing.

In this case, it can be seen that with respect to the normal line NL from the surface of each of the plurality of reflective units 21 to 25, the incidence angle θᵢₙ of the virtual image light output from a single point S and incident on the plurality of reflective units 21 to 25 gradually decreases from the uppermost reflective unit 21 to the lowermost reflective unit 25.

In this case, the point S from which the virtual image light is output corresponds to a point on the second surface 12 of the optical means 10.

Accordingly, due to the properties of the dielectric coating layer 202 described above, the reflectance of the virtual image light reflected from the plurality of reflective units 21 to 25 and transferred to the pupil 40 decreases from top to bottom.

Meanwhile, the intensity of light reflected from each of the plurality of reflective units 21 to 25 and transferred to the pupil 40 is proportional to the effective area x reflectance of each of the plurality of reflective units 21 to 25.

In this case, the effective area of each of the plurality of reflective units 21 to 25 refers to the area of the orthogonal projection of each of the plurality of reflective units 21 to 25 onto the pupil 40, and the reflectance refers to the ratio of the amount of virtual image light transferred to the pupil 40 to the amount of virtual image light incident on each of the plurality of reflective units 21 to 25.

Accordingly, as shown in FIG. 7, when the inclination angles θᵣ of the plurality of reflective units 21 to 25 with respect to straight lines parallel to the normal line NP from the pupil 40 are all the same, the effective area of each of the plurality of reflective units 21 to 25 gradually increases from top to bottom, but the reflectance of each of the plurality of reflective units 21 to 25 gradually decreases from top to bottom. The reason for this is that, as described above, the incident angle θᵢₙ of the incident light with respect to the normal line NL from the surface of each of the plurality of reflective units 21 to 25 becomes smaller.

The intensity of light reflected from each of the plurality of reflective units 21 to 25 and transferred to the pupil 40 is proportional to the product of the effective area and reflectance of each of the plurality of reflective units 21 to 25, and the effective area and the reflectance are inversely proportional to each other. Accordingly, it can be seen that in a structure such as that shown in FIG. 7, the differences in the intensity of light reflected from each of the plurality of reflective units 21 to 25 and transferred to the pupil 40 may be reduced.

That is, when the product of the effective area and reflectance of each of the plurality of reflective units 21 to 25 has a value within a predetermined range, luminous uniformity for the virtual image may be increased.

In this case, the value within the predetermined range is preferably within the range of ±30% of a preset constant value, and more preferably within the range of ±10% thereof.

Accordingly, compared to the prior art without the dielectric coating layer 202, the differences in the intensity of light reflected from each of the plurality of reflective units 21 to 25 and transferred to the pupil 40 may be significantly reduced, and the luminous uniformity of the virtual image light in the plurality of reflective units 21 to 25 may be maintained within a predetermined range.

According to the experimental results of the present applicant, the luminous uniformity of the virtual image light reflected from each of the plurality of reflective units 21 to 25 was measured to be about 84.5%. It was found that the luminous uniformity was increased by about 1.7 times compared to about 50.45% in the prior art without the dielectric coating layer 202.

Meanwhile, this principle may be applied regardless of the inclination angles θᵣ and arrangement structure of the plurality of reflective units 21 to 25 disposed in the optical means 10.

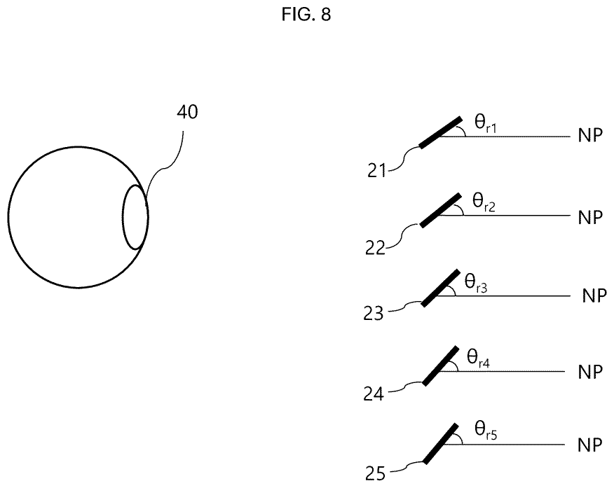

FIG. 8 shows a side view of an optical device 100 according to another embodiment of the present invention.

The embodiment of FIG. 8 is basically the same as that of FIG. 7, except that the inclination angles θᵣ₁ to θᵣ₅ of the plurality of reflective units 21 to 25 with respect to straight lines parallel to the normal line NP in the forward direction from the pupil 40 are not all the same.

In FIG. 8, for convenience of illustration, the optical paths of virtual image light are omitted.

Referring to FIG. 8, the plurality of reflective units 21 to 25 are arranged such that the inclination angles θᵣ₁ to θᵣ₅ thereof gradually increase from top to bottom, as shown in the drawing.

Even in this case, the principle described with reference to FIG. 7 may be applied without change. In other words, the effective area of each of the plurality of reflective units 21 to 25 gradually increases from top to bottom, but the reflectance decreases. Accordingly, for the same reason as described above, the intensity of light reflected from each of the plurality of reflective units 21 to 25 and transmitted to the pupil 40 may be maintained within a predetermined range.

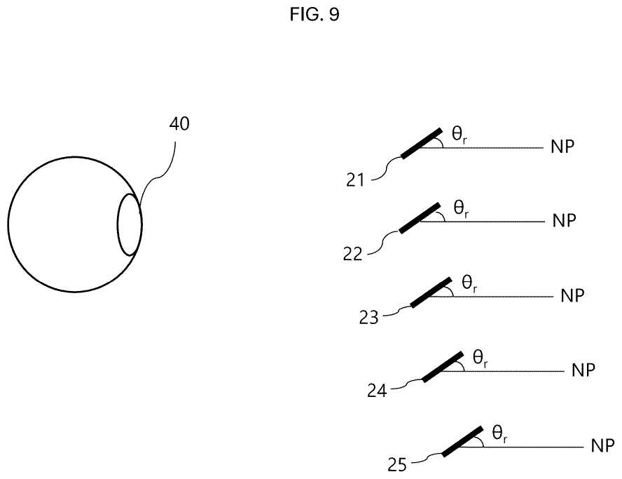

FIG. 9 shows a side view of an optical device 100 according to still another embodiment of the present invention.

The optical device 100 of FIG. 9 is basically the same as that of FIG. 7, except that the centers of the plurality of respective reflective units 21 to 25 are not located on a vertical line when viewed from a side, as shown in the drawing.

That is, in FIG. 9, when viewed from the side, the plurality of reflective units 21 to 25 are arranged such that their respective centers are located on a gentle curve.

Even in this case, the principle described with reference to FIG. 7 may be applied without change, so that a detailed description thereof will be omitted.

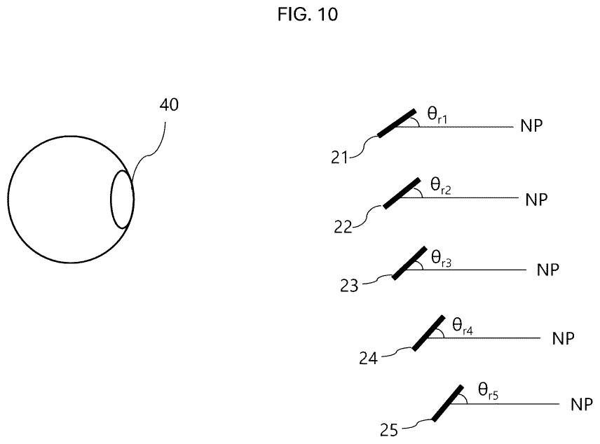

FIG. 10 shows a side view of an optical device 100 according to still another embodiment of the present invention.

The optical device 100 of FIG. 10 is basically the same as that of FIG. 9, except that the inclination angles θᵣ₁ to θᵣ₅ of the plurality of respective reflective units 21 to 25 with respect to straight lines parallel to the normal line NP in the forward direction from the pupil 40 are not all the same. As described in FIG. 8, the plurality of reflective units 21 to 25 are arranged such that the inclination angles θᵣ₁ to θᵣ₅ thereof gradually increase from top to bottom.

Even in this case, the principle described with reference to FIG. 7 may be applied without change, so that a detailed description thereof will be omitted.

Referring to the examples described in FIGS. 7 to 10, the intensity of virtual image light reflected from each of the plurality of reflective units 21 to 25 is proportional to the effective area×reflectance of each of the plurality of reflective units 21 to 25.

Accordingly, it can be seen that as long as the effective area and reflectance of each of the plurality of reflective units 21 to 25 are inversely proportional to each other, luminous uniformity for virtual image light may be increased by the dielectric coating layer 202 according to the present invention regardless of the inclination angles or arrangement structure of the plurality of reflective units 21 to 25 disposed in the optical means 10.

Meanwhile, although the inclination angles θᵣ₁ to θᵣ₅ of the plurality of respective reflective units 21 to 25 are described as not being the same in the embodiments of FIGS. 8 and 10, this is an example. It does not matter if the inclination angles θᵣ₁ to θᵣ₅ of at least some of the plurality of reflective units 21 to 25 are different.

Furthermore, although the reflectances of the plurality of reflective units 21 to 25 are described as being all the same in the above embodiment, they do not necessarily all need to be the same. At least some of the plurality of reflective units 21 to 25 may have a different reflectance.

For example, the plurality of reflective units 21 to 25 may be coated with different dielectric materials exhibiting different reflectances, respectively, when the incident angles of incident light are the same, so that the plurality of reflective units 21 to 25 can have different reflectances.

Alternatively, even when the same dielectric material is used, the plurality of reflective units 21 to 25 may have different reflectances by adjusting the areas or thicknesses of the plurality of reflective units 21 to 25.

In this case, as described above, the intensity of light reflected from each of the plurality of reflective units 21 to 25 is proportional to the product of the effective area and reflectance of each of the plurality of reflective units 21 to 25. Accordingly, each of the plurality of reflective units 21 to 25 is allowed to have the reflectance varying depending on the effective area of each of the plurality of reflective units 21 to 25. As a result, the intensity of light reflected from each of the plurality of reflective units 21 to 25 may be adjusted to a predetermined constant value or within a predetermined range.

Therefore, it is preferable that each of the plurality of reflective units 21 to 25 be allowed to have a different reflectance by setting the reflectance of each of the plurality of reflective units 21 to 25 so that the product of the effective area and reflectance of each of the plurality of reflective units 21 to 25 falls within a predetermined range and forming the dielectric coating layer 202 through coating with a dielectric material corresponding to the set reflectance.

In this case, the predetermined range is preferably the range of ±30% of a preset constant value, and more preferably the range of ±10% thereof.

Meanwhile, the reflective members 201 of the plurality of reflective units 21 to 25 are preferably reflective means that reflect incident virtual image light.

In this case, it is preferable that the reflective members 201 of the plurality of reflective units 21 to 25 be full mirrors that are made of a metallic material having a high reflectance of 100% or close thereto.

Alternatively, the reflective members 201 of the plurality of reflective units 21 to 25 may be half mirrors that transmit part of incident light therethrough and reflect part thereof.

Alternatively, instead of each of the reflective members 201 of the plurality of reflective units 21 to 25, any one of a diffractive element, a holographic element, a refractive element, and a combination of one or more thereof may be used.

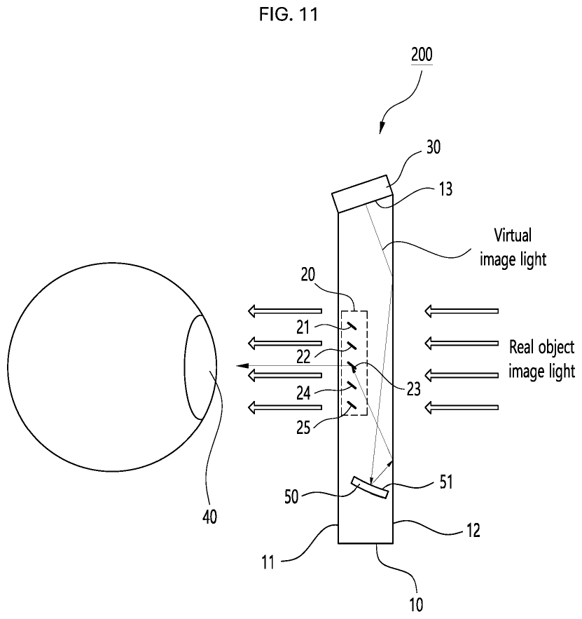

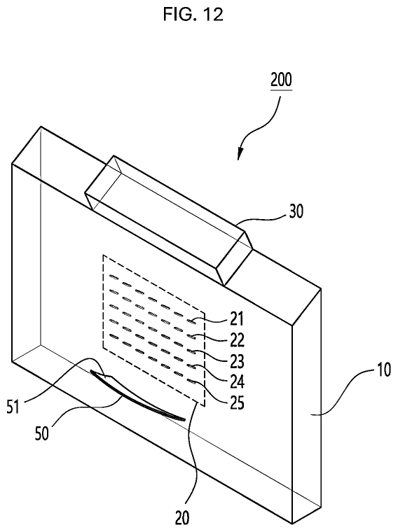

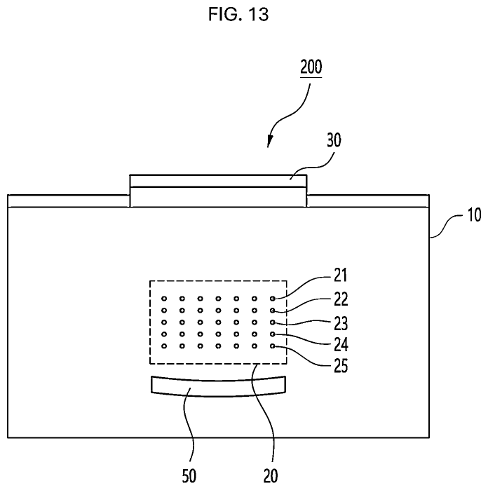

FIGS. 11 to 13 show a side view, perspective view, and front view, respectively, of an optical device 200 according to still another embodiment of the present invention.

The optical device 200 of FIGS. 11 to 13 is basically the same as the optical device 100 described in FIGS. 1 to 3, except that a light conversion unit 50 is disposed in an optical means 10.

Although the light conversion unit 50 is included in the image output unit 30 in the optical device 100 of the embodiment of FIGS. 1 to 3, it is disposed inside the optical means 10 in the optical device 200. Accordingly, the light conversion unit 50 may be omitted from an image output unit 30, so that there is the advantage of keeping the form factor of the image output unit 30 small.

In the optical device 200 of FIGS. 11 to 13, the virtual image light output from the image output unit 30 is reflected by total internal reflection on the second surface 12 of the optical means 10 and is transferred to the light conversion unit 50. The virtual image light output from the light conversion unit 50 is reflected by total internal reflection again on the second surface 12 of the optical means 10 and is transferred to a plurality of reflective units 21 to 25.

Accordingly, each of the plurality of reflective units 21 to 25 is disposed at an appropriate inclination angle inside the optical means 10 by taking into consideration the above optical paths. For example, the inclination angles of the plurality of reflection units 21 to 25 are symmetrical with respect to a vertical axis compared to the optical device 100 of FIGS. 1 to 3.

However, this is an example. It is obvious that a configuration may be made such that the virtual image light output from the light conversion unit 50 may be directly transferred to the plurality of reflective units 21 to 25 without total internal reflection.

In this optical device 200, the plurality of reflective units 21 to 25 each have a dielectric coating layer 202 formed on a reflective surface that transfers incident virtual image light by reflecting it, and the luminous uniformity of a virtual image may be increased by the same principle as described above.

However, in the optical device 100, the effective area increases and the reflectance decreases from top to bottom. In contrast, in the optical device 200, the virtual image light incident on the plurality of reflective units 21 to 25 is transferred from the light conversion unit 50 disposed below, so that there is a relationship in which the effective area increases and the reflectance decreases from bottom to top. Accordingly, high luminous uniformity may be obtained in the optical device 200 by the same principle.

Since other configurations are the same as those described with reference to FIGS. 1 to 10, detailed descriptions thereof will be omitted.

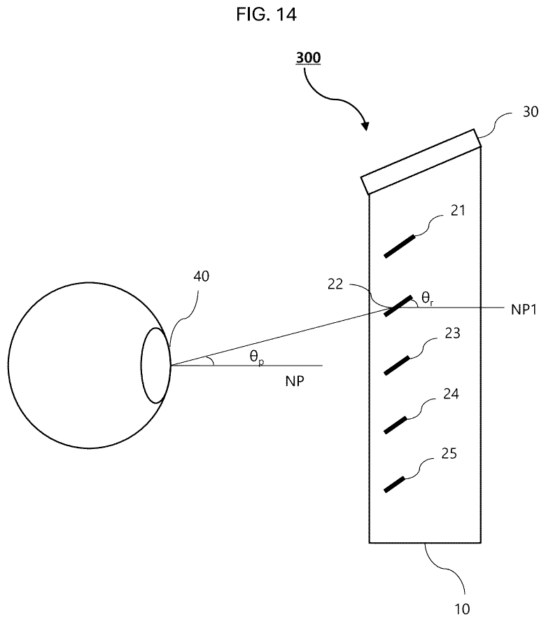

FIG. 14 shows a side view of an optical device 300 according to still another embodiment of the present invention.

The optical device 300 of FIG. 14 is similar to the optical device 100 described in FIGS. 1 to 3, except that luminous uniformity is increased by adjusting the effective area of each of the plurality of reflective units 21 to 25 instead of forming the dielectric coating layer 202 on each of the plurality of reflective units 21 to 25.

That is, the optical device 300 of FIG. 14 is characterized in that the plurality of reflective units 21 to 25 are made of a metallic reflective material such as Ag or Al and have the same reflectance and the actual size of each of the plurality of reflective units 21 to 25 is formed such that the effective area of each of the plurality of reflective units 21 to 25 has a value in a preset range.

This is based on the following principles:

That is, as described above, the intensity of light reflected from each of the plurality of reflective units 21 to 25 and transferred to the pupil 40 is proportional to the effective area×reflectance of each of the plurality of reflective units 21 to 25.

When the actual sizes (areas) of the plurality of reflective units 21 to 25 are all the same, the effective area of each of the plurality of reflective units 21 to 25 gradually increases from top to bottom, as described above.

In this case, when the reflectances of the plurality of reflective units 21 to 25 are all the same, the intensity of light reflected from the lower reflective unit 25 becomes higher.

Therefore, in the case where the reflectances of the plurality of reflective units 21 to 25 are all the same, when the effective area of each of the plurality of reflective units 21 to 25 decreases downward, the intensity of light reflected from each of the plurality of reflective units 21 to 25 may be maintained within a predetermined range.

Referring to FIG. 14, when the inclination angle between the normal line NP from the pupil 40 and the center of each of the plurality of reflective units 21 to 25 is θₚ, the inclination angle of each of the plurality of reflective units 21 to 25 with respect to the straight line NP1 parallel to the normal line NP from the pupil 40 and extending from the center of each of the plurality of reflective units 21 to 25 is θᵣ, and the actual size (area) of each of the plurality of reflective units 21 to 25 is A(θₚ), the effective area A_{eff} of each of the plurality of reflective units 21 to 25 may be calculated using Equation 1 below:

$${A}_{eff} = A ( {θ}_{p} ) \times sin ( {θ}_{r} - {θ}_{p} ) \qquad ( 1 )$$

In order for the effective area A_{eff} of each of the plurality of reflective units 21 to 25 to be a preset constant Aₒ, Equation 2 below is derived from Equation 1 above.

$$A ( {θ}_{p} ) = {A}_{o} / sin ( {θ}_{r} - {θ}_{p} ) \qquad ( 2 )$$

This means that in order for the effective area of the plurality of reflective units 21 to 25 to be a constant value, the actual size (area) (=A(θₚ)) of each of the plurality of reflective units 21 to 25 needs to change by the factor “1/sin(θᵣ−θₚ).”

That is, the actual size (area) (=A(θₚ)) of each of the plurality of reflective units 21 to 25 needs to have a valve obtained by dividing the preset constant Aₒ by sin(θᵣ−θₚ).

Accordingly, based on this principle, the plurality of reflective units 21 to 25 shown in FIG. 14 are arranged such that the actual size of each of the plurality of reflective units 21 to 25 gradually decreases from top to bottom.

Meanwhile, although the effective area A_{eff} has been described above as being the preset constant Aₒ, it may also have a value within a preset range based on the constant Aₒ.

For example, the preset range is preferably the range of ±30% of the preset constant Aₒ, and more preferably the range of ±10% thereof.

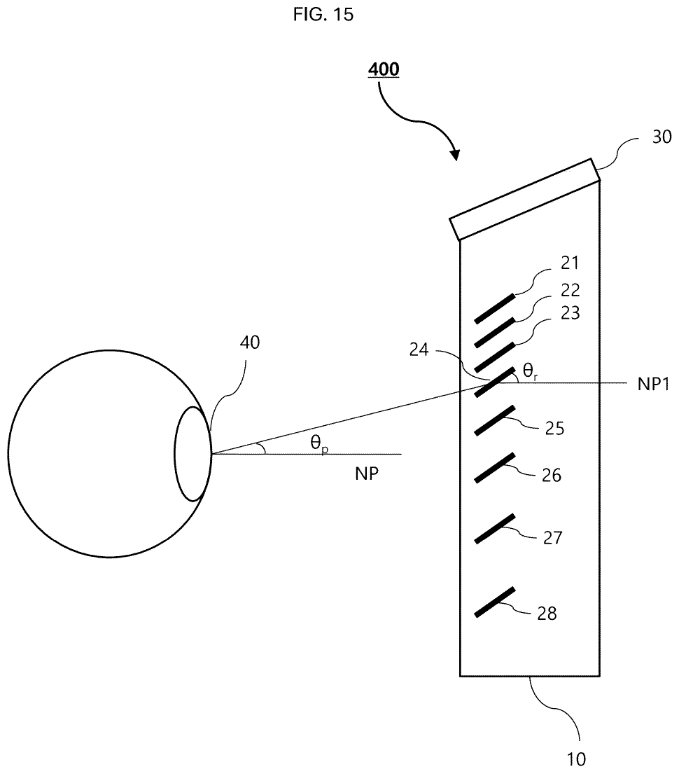

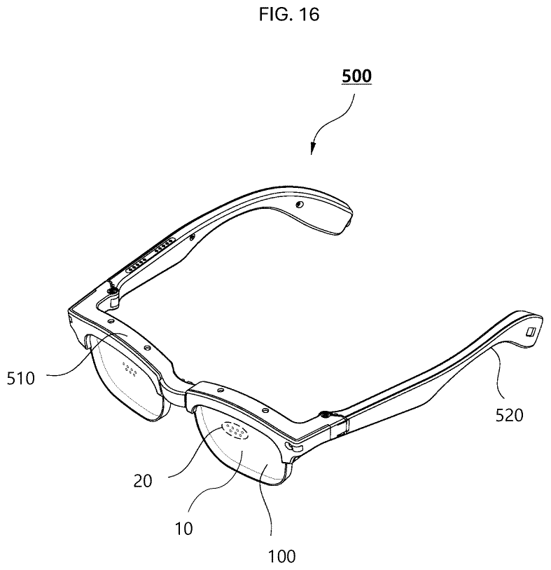

FIG. 15 shows a side view of an optical device 400 according to still another embodiment of the present invention.

The optical device 400 of FIG. 15 is similar to the optical device 300 of FIG. 14, except that luminous uniformity is increased by adjusting the intervals between the plurality of reflective units 21 to 28 instead of adjusting the effective area of each of the plurality of reflective units 21 to 25.

In FIG. 15, the plurality of reflective units 21 to 28 have the same actual size and reflectance, but the plurality of reflective units 21 to 28 are arranged at the intervals that allow the density based on the effective area of each of the plurality of reflective units 21 to 28 to have a value within a preset constant range.

In this case, the density based on the effective area refers to the size of the effective area of each of the plurality of reflective units 21 to 28 relative to the space where the plurality of reflective units 21 to 28 are arranged when the plurality of reflective units 21 to 28 are viewed from the pupil 40.

Referring to FIG. 15, it can be seen that the intervals between the upper reflective units 21 to 24 are shorter whereas the intervals gradually increase downward.

This is based on the following principles:

That is, the intensity (quantity) of light reflected from each of the plurality of reflective units 21 to 28 is independent of the inclination angle θₚ between the normal line NP from the pupil 40 and the center of each of the plurality of reflective units 21 to 28. This means that the intensity (quantity) of light reflected from each of the plurality of reflective units 21 to 28 is not a function of θₚ.

The intensity (quantity) of light reflected from each of the plurality of reflective units 21 to 28 may be represented by N(θₚ)×effective area θₚ×reflectance R.

In this case, N(θₚ) refers to the density based on the effective area of each of the plurality of reflective units 21 to 28.

By differentiating the above equation, Equation 3 below may be obtained:

$$d ( \frac{intensity ( quanity ) of light}{d {θ}_{p}} ) = \frac{d ( N ( {θ}_{p} ) * {A}_{eff} * R )}{d {θ}_{p}} \qquad ( 3 )$$

where the effective area A_{eff} is A_{eff}=A(θₚ)×sin(θᵣ−θₚ) and A(θₚ) all have the same value Aₒ, as described with reference to FIG. 14.

Since the reflectances R are also the same, Equation 3 may be represented as follows:

$$\frac{R * {A}_{0} * d ( N ( {θ}_{p} ) * sin ( {θ}_{r} - {θ}_{p} ) )}{d θ} \qquad ( 4 )$$

As described above, the intensity (quantity) of light is not a function of θₚ, so that in order for Equation 4 to be 0, Equation 5 below needs to be satisfied:

$$N ( {θ}_{p} ) * sin ( {θ}_{r} - {θ}_{p} ) = {C}_{0} \qquad ( 5 )$$

where C₀ is a constant.

From this, Equation 6 below may be obtained:

$$N ( {θ}_{p} ) = {C}_{0} / sin ( {θ}_{r} - {θ}_{p} ) \qquad ( 6 )$$

That is, a predetermined luminous uniformity may be obtained when the density N(θₚ) based on the effective area of each of the plurality of reflective units 21 to 28 changes by the factor “1/sin(θᵣ−θₚ).”

The actual sizes (areas) of the plurality of reflective units 21 to 28 in the optical device 400 of FIG. 15 are all the same. Accordingly, the density N(θₚ) based on the effective area of each of the plurality of reflective units 21 to 28 needs to be allowed to satisfy Equation 6 above by adjusting the intervals between the plurality of reflective units 21 to 28.

That is, the plurality of reflective units 21 to 28 need to be arranged such that the density N(θₚ) based on the effective area of each of the plurality of reflective units 21 to 28 has a value obtained by dividing the preset constant C₀ by sin(θᵣ−θₚ).

Based on this principle, the plurality of reflective units 21 to 28 of FIG. 15 have the same actual size (area), and are arranged such that the interval between them gradually increases from top to bottom.

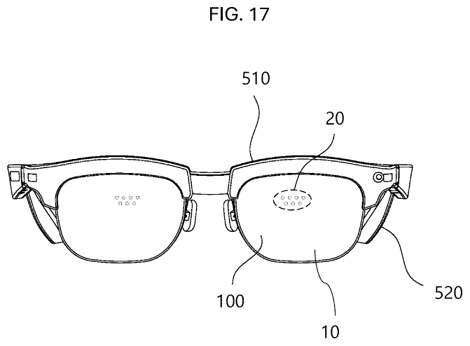

FIGS. 16 and 17 show a perspective view and front view, respectively, of an embodiment of a glasses-type augmented reality provision device 500 implemented in the form of smart glasses.

Referring to FIGS. 16 and 17, the glasses-type augmented reality provision device 500 is formed in the overall shape of glasses and includes optical devices 100 such those described with reference to FIGS. 1 to 15, a frame unit 510, and fixation units 520.

The frame unit 510 is a means that fixes the optical devices 100. Although the frame unit 510 is formed only on the tops of the optical means 10 in FIGS. 16 and 17, it may also be formed to surround the overall outer peripheral surfaces of the optical means 10.

Image output units 30 may be embedded and disposed in the upper portion of the frame unit 510.

The fixation units 520 are coupled to the frame unit 510 and are means that fix the glasses-type augmented reality provision device 500 so that it can be worn on the face of a user. As shown in the drawings, the fixation units 520 may be formed in the form of a pair of temples that allow the glasses-type augmented reality provision device 500 to be worn on the ears of the user.

Although not shown in the drawings, a connection port (not shown) may be formed at an end of the fixation units 520 so that it can be connected to a smartphone or computer, and a data cable connected to the connection port and the cable of a display may be placed inside the fixation units 520 and the frame unit 510.

Through this configuration, still or moving image data may be received from the smartphone or computer, the received data may be transferred to and displayed on the display units of the image output units 30, and virtual image light may be output from these display units.

According to this augmented reality provision device 500, it may be possible to provide “smart glasses” having a shape similar to the shape of conventional glasses that provide desirable wearing comfort and minimize a sense of heterogeneity compared to the prior art.

According to the present invention, there may be provided the optical device for augmented reality that can increase luminous uniformity for virtual image light.

Although the present invention has been described above with reference to the embodiments of the present invention, these are illustrative. It will be apparent to those having ordinary skill in the art to which the present invention pertains that various other modifications and alterations may be made within the scope of the present invention defined based on the attached claims and drawings. It should be noted that all such modifications and variations are included within the scope of equivalent rights of the present invention.

What is claimed is:

1. An optical device for augmented reality, the optical device comprising:
an optical means configured to allow virtual image light, output from an image output unit, to propagate through an interior thereof and transmit real object image light therethrough toward a pupil of a user; and
a plurality of reflective units disposed in the optical means to transfer the virtual image light toward the pupil of the user;
wherein the plurality of reflective units are each configured such that a dielectric coating layer coated with a dielectric material is formed on a reflective surface thereof that reflects incident virtual image light and transfers it to the pupil.

2. The optical device of claim 1, wherein the dielectric material is at least any one of SiO₂, TiO₂, Al₂O₃, fluorinated ethylene propylene (FEP), polyvinylidene fluoride (PVDF), perfluoroalkoxy (PFA), ethylene tetrafluoroethylene (ETFE), and polyethylene terephthalate (PET).

3. The optical device of claim 1, wherein the dielectric coating layer is transparent.

4. The optical device of claim 1, wherein a product of an effective area and reflectance of each of the plurality of reflective units has a value within a predetermined range.

5. The optical device of claim 4, wherein the value within the predetermined range is within a range of ±30% of a preset constant value.

6. The optical device of claim 1, wherein at least some of the plurality of reflective units have a different reflectance.

7. The optical device of claim 1, wherein for the plurality of reflective units, a reflectance of each of the plurality of reflective units is set such that a product of an effective area and reflectance of each of the plurality of reflective units falls within a predetermined range, and the dielectric coating layer is formed by performing coating with a dielectric material corresponding to the set reflectance.

8. The optical device of claim 7, wherein the predetermined range is a range of ±30% of a preset constant value.

9. The optical device of claim 1, wherein:
the plurality of reflective units each include a reflective member made of a metallic material; and
the dielectric coating layer is formed on a reflective surface of the reflective member that transfers incident virtual image light to the pupil by reflecting it.

10. An optical device for augmented reality, the optical device comprising:
an optical means configured to allow virtual image light, output from an image output unit, to propagate through an interior thereof and transmit real object image light therethrough toward a pupil of a user; and
a plurality of reflective units disposed in the optical means to transfer the virtual image light toward the pupil of the user;
wherein the plurality of reflective units have a same reflectance; and
wherein a size of each of the plurality of reflective units is formed such that an effective area of each of the plurality of reflective units has a value in a preset range.

11. The optical device of claim 10, wherein a size (A(θₚ)) of each of the plurality of reflective units has a value obtained by dividing a preset constant (A₀) by sin(θᵣ−θₚ) (where θₚ is an inclination angle between a normal line (NP) from the pupil and a center of each of the plurality of reflective units, and θᵣ is an inclination angle of each of the plurality of reflective units with respect to a straight line (NP1) parallel to the normal line (NP) from the pupil and extending from the center of each of the plurality of reflective units).

12. An optical device for augmented reality, the optical device comprising:
an optical means configured to allow virtual image light, output from an image output unit, to propagate through an interior thereof and transmit real object image light therethrough toward a pupil of a user; and
a plurality of reflective units disposed in the optical means to transfer the virtual image light toward the pupil of the user;
wherein the plurality of reflective units have a same reflectance and size; and
wherein the plurality of reflective units are arranged at intervals that allow a density based on an effective area of each of the plurality of reflective units to have a value within a predetermined range.

13. The optical device of claim 12, wherein the plurality of reflective units are arranged at intervals that allow the density (N(θₚ)) based on the effective area of each of the plurality of reflective units to have a value obtained by dividing a preset constant (C₀) by sin(θᵣ−θₚ) (where θₚ is an inclination angle between a normal line (NP) from the pupil and a center of each of the plurality of reflective units, and θᵣ is an inclination angle of each of the plurality of reflective units with respect to a straight line (NP1) parallel to the normal line (NP) from the pupil and extending from the center of each of the plurality of reflective units).

14. A glasses-type augmented reality provision device comprising:
optical devices for augmented reality each set forth in claim 1;
a frame unit configured such that the optical devices for augmented reality are fixed thereto; and
fixation units configured to be coupled to the frame unit and fix the glasses-type augmented reality provision device so that it can be worn on a face of a user.

15. A glasses-type augmented reality provision device comprising:
optical devices for augmented reality each set forth in claim 10;
a frame unit configured such that the optical devices for augmented reality are fixed thereto; and
fixation units configured to be coupled to the frame unit and fix the glasses-type augmented reality provision device so that it can be worn on a face of a user.

16. A glasses-type augmented reality provision device comprising:
optical devices for augmented reality each set forth in claim 12;
a frame unit configured such that the optical devices for augmented reality are fixed thereto; and
fixation units configured to be coupled to the frame unit and fix the glasses-type augmented reality provision device so that it can be worn on a face of a user.
